(19) United States
(12) Patent Application Publication
(10) Pub. No.: US 2011/0032580 A1
(43) Pub. Date: Feb. 10, 2011

(54) SCANNING DEVICE AND SCANNING METHOD THEREOF

(75) Inventor: Yong-Xiang Yi, SuZhou City (CN)

Correspondence Address: COVENANT IP CONSULTING CO., P.O. BOX 34-306 TAIPEI CITY, TAIPEI, 10499, TW

(73) Assignee: Qisda (SuZhou) Co., ltd, Suzhou (CN)

(21) Appl. No.: 12/814,480

(22) Filed: Jun. 13, 2010

(30) Foreign Application Priority Data
Aug. 7, 2009 (CN) 200910163864.4

(51) Int. Cl. H04N 1/00

(52) U.S. Cl. 358/406

(57) ABSTRACT

A scanning device and a scanning method thereof are provided. The scanning device includes a scanning group, a paper-feed roller and a calibration portion. The scanning group includes a line light source generating module and a scanning module. The line light source generating module includes a point light source, a light-guiding plate and a casing. The light emitted by the point light source along a first direction is converted into a line light source through a light-guiding plate disposed in the casing. The light emitted by the line light source along a second direction is emitted from an opening of the casing. The scanning module, along the first direction, includes a scan document region and a calibration region. The light reflected through the to-be-scanned document is received in the scan document region. The calibration portion disposed on the casing or the paper-feed roller corresponds to the calibration region.

This application claims the benefit of People's Republic of China application Serial No. 200910163864.4, filed Aug. 7, 2009, the subject matter of which is incorporated herein by reference.

### BACKGROUND OF THE INVENTION

1. Field of the Invention

The invention relates in general to a scanning device and a scanning method thereof, and more particularly to a scanning device with automatic calibration of brightness and colors and a scanning method thereof.

2. Description of the Related Art

The portable scanner normally adopts the contact image sensor (CIS) as an image collecting element, and the color CIS normally adopts the RGB (red/green/blue) light emitting diodes (LEDs) as a light source for illumination. Inside the portable scanner, electronic elements such as motor, driving circuit board and LED light source generate heat during operation. The temperature inside the scanning device changes accordingly with the change in the temperature of the working environment, and such change leads to the change in the LED brightness of the CIS and subsequently changes the brightness of the scan image. Since the RGB LEDs do not change with the temperature change in a uniform manner, the RGB colors of the scan image have respective changes which are different from one another. And the difference in the change of the RGB colors is reflected in the scan image as color aberration.

A generally known solution to resolve the problem of color aberration is to perform color calibration using a particular white document as a standard document before the scanning process is performed. In general, the standard document is fixed in the scanning device and the length of the standard document is slightly larger than that of the CIS. The CIS reads the standard document and adjusts the exposure time of the LED according to the comparison between the standard document and the pre-determined brightness value of image so as to control the brightness of the scan image. Besides, the brightness data of the standard document obtained by the CIS can be used for calibrating the brightness difference among the pixels so that the brightness of the obtained image is uniform. The above method is normally adapted in the flat-bed scanner. Due to the restrictions in the design, the portable scanner or the paper-feed scanner normally does not provide the standard document that is fixed in the scanning device. Instead, the portable scanner or the paper-feed scanner provides an extra standard document for the user to decide when to perform calibration. Unlike the flat-bed scanner, the portable scanner or the paper-feed scanner cannot perform at anytime.

However, a problem arises. That is, after a scanner has worked for a period of time, or the environmental temperature of the scanner has changed, the brightness of the LED of the CIS will change due to the change in the environmental temperature, and such brightness change will make the brightness of the scanned image change or even result in color aberration.

### SUMMARY OF THE INVENTION

The invention is provided to resolve the above technical problems. The light emitted from the LED light source of a CIS is reflected to a part of the sensing elements of the CIS through a calibration portion. The intensity of the reflected light is examined by the part of the sensing elements in real time, and the brightness of the LED light source is feedbacked to a control system which accordingly adjusts the brightness of the LED light source by controlling relevant circuits of the LED light source.

The scanning device of the invention includes a scanning group, a f paper-feed roller and a calibration portion. The scanning group includes a line light source generating module and a scanning module. The line light source generating module includes a point light source, a light-guiding plate and a casing. The light emitted by the point light source along a first direction is converted into a line light source through a light-guiding plate disposed in the casing. The light emitted by the line light source along a second direction is emitted from an opening of the casing. The scanning module includes a scan document region and a calibration region along the first direction. The light reflected through the to-be-scanned document is received in the scan document region. The paper-feed roller is disposed adjacent to the scanning group. The calibration portion is disposed on the casing or the paper-feed roller and corresponds to the calibration region of the scanning module, and the light reflected through the calibration portion is received in the calibration region.

According to the scanning device of the invention, the calibration portion is a reflection layer disposed around the paper-feed roller.

According to the scanning device of the invention, the calibration portion and the casing are integrally formed in one piece.

The scanning device of the invention further includes a light source control circuit and a calibration control system. The light source control circuit is for controlling the illumination parameters of the line light source generating module. The calibration control system is electrically connected to the scanning module and the light source control circuit for adjusting the light source control circuit according to the signal feedbacked from the calibration region.

According to the scanning device of the invention, the point light source is RGB light emitting diodes.

According to the scanning device of the invention, the scanning module includes a cylindrical lens array and a contact image sensor (CIS) array, and the reflected light is received by the CIS array through the cylindrical lens array.

The scanning method of the invention includes the following steps. In step A, a calibration portion corresponding to a calibration region of a scanning module is provided. In step B, a document is pre-scanned, the light emitted by a light source is reflected through the calibration portion and received in the calibration region, and, at the same time, a first brightness signal is generated. In step C, the first brightness signal is compared to a pre-determined signal. In step D, if the difference between the first brightness signal and the pre-determined signal is greater than a reference value, then the light source is adjusted, and the step B is repeated. In step E, if the difference between the first brightness signal and the pre-determined signal is smaller than or equal to the reference value, then a document is formally scanned.

According to the scanning method of the invention, the scanning module, along the first direction, further includes a scan document region, and the light emitted by the light source is reflected through the to-be-scanned document and received in the scan document region.

According to the scanning method of the invention, before the step B, the brightness or an exposure time of the light source is pre-determined.

According to the scanning method of the invention, in the step D, an exposure time of the light source is increased or decreased.

To resolve the problems such as color aberration and brightness change, which occur to the portable scanner due to temperature change, the invention provides a scanning device with automatic calibration of brightness and colors, so that the user no more need to perform manual calibration after the occurrence of brightness change or color aberration. The invention provides the user with great convenience.

The invention will become apparent from the following detailed description of the preferred but non-limiting embodiments. The following description is made with reference to the accompanying drawings.

### BRIEF DESCRIPTION OF THE DRAWINGS

FIG. 1 shows a structural diagram of a scanning device according to an embodiment of the invention;

FIG. 2 shows a position diagram of a calibration portion according to an embodiment of the invention;

FIG. 3 shows a system diagram of a scanning device according to an embodiment of the invention;

FIG. 4 shows a structural diagram of a scanning device according to another embodiment of the invention;

FIG. 5 shows a position diagram of a calibration portion according to another embodiment of the invention;

FIG. 6 shows a scan document region and a calibration region according to another embodiment of the invention;

FIG. 7A and FIG. 7B respectively show a structural diagram of a scanning device according to yet another embodiment of the invention;

FIG. 8 shows a flowchart of a scanning method according to an embodiment of the invention; and

FIG. 9 shows a flowchart of a scanning method according to another embodiment of the invention.

### DETAILED DESCRIPTION OF THE INVENTION

Detailed descriptions of the objects, structures, features and functions of the invention are disclosed in a number of embodiments below.

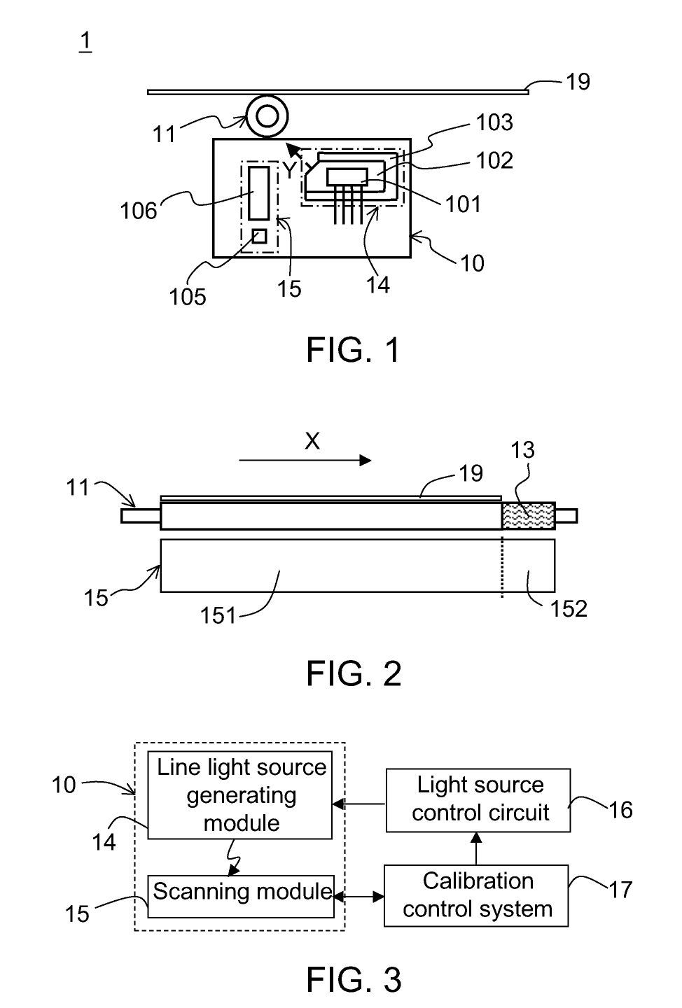

Referring to FIG. 1 and FIG. 2. FIG. 1 shows a structural diagram of a scanning device 1 according to an embodiment of the invention. FIG. 2 shows a position diagram of a calibration portion 13 according to an embodiment of the invention. The scanning device 1 includes a scanning group 10, a paper-feed roller 11 and a calibration portion 13. The scanning group 10 includes a line light source generating module 14 and a scanning module 15. The line light source generating module 14 includes a point light source 101, a light-guiding plate 102 and a casing 103. The light emitted by the point light source 101 along a first direction X is converted into a line light source through the light-guiding plate 102. The light-guiding plate 102 is disposed in the casing 103. The light emitted by the line light source along a second direction Y is emitted from the opening of the casing 103. The scanning module 15, along the first direction X, includes a scan document region 151 and a calibration region 152. The light reflected through the to-be-scanned document 19 is received in the scan document region 151. The paper-feed roller 11 is disposed adjacent to the scanning group 10 for driving the to-be-scanned document 19. The calibration portion 13 is disposed on the paper-feed roller 11 and corresponds to the calibration region 152 of the scanning module 15. The light reflected through the calibration portion 13 is received in the calibration region 152.

In an embodiment, the calibration portion 13 is a reflection layer disposed around the paper-feed roller 11. In practical application, the calibration portion 13 has a white reflective coating layer. The point light source 101 is red/green/blue (RGB) light emitting diodes (LEDs). Preferably, the first direction X is perpendicular to the second direction Y.

In an embodiment, the scanning module 15 includes a cylindrical lens array 106 and a contact image sensor (CIS) array 105. The reflected light is received by the CIS array 105 through the cylindrical lens array 106. The CIS array 105, along the first direction X, includes a scan document region 151 and a calibration region 152. The light reflected through the to-be-scanned document 19 is received in the scan document region 15 by a part of the sensing elements, and the light reflected through the calibration portion 13 is received in the calibration region 152 by the other part of the sensing elements.

Also referring to FIG. 3, a system diagram of a scanning device 1 according to an embodiment of the invention is shown. The scanning device 1 further includes a light source control circuit 16 and a calibration control system 17. The light source control circuit 16 is for controlling the illumination parameters of the line light source generating module 14. The calibration control system 17 is electrically connected to the scanning module 15 and the light source control circuit 16 for adjusting the light source control circuit 16 according to the signal feedbacked from the calibration region 152.

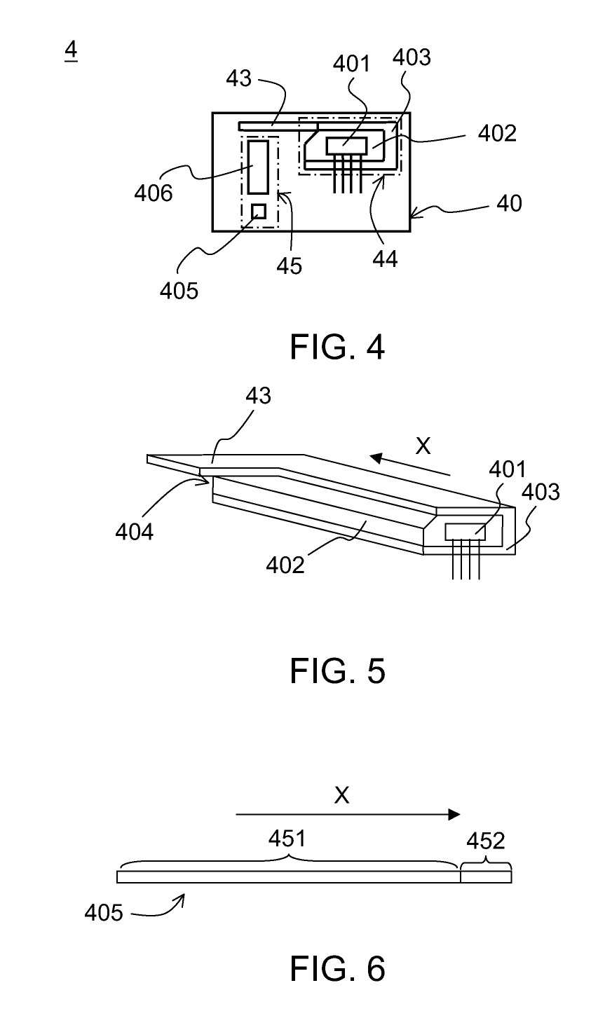

Continue to refer to FIG. 4 and FIG. 5. FIG. 4 shows a structural diagram of a scanning device 4 according to another embodiment of the invention. FIG. 5 shows a position diagram of a calibration portion 43 according to another embodiment of the invention. The scanning device 4 includes a scanning group 40 and a calibration portion 43. The scanning group 40 includes a line light source generating module 44 and a scanning module 45. The line light source generating module 44 includes a point light source 401, a light-guiding plate 402 and a casing 403. The light emitted by the point light source 401 along a first direction X is converted into a line light source through the light-guiding plate 402 disposed in the casing 403. The light emitted by the line light source along a second direction is emitted from the opening 404 of the casing 403. The scanning module 45, along the first direction X, includes a scan document region and a calibration region. The light reflected through the to-be-scanned document is received in the scan document region. The calibration portion 43 is disposed on the casing 403 and corresponds to the calibration region of the scanning module 45. The light reflected through the calibration portion 43 is received in the calibration region.

In practical application, the calibration portion 43 and the casing 403 are integrally formed in one piece. In the first direction X, the length of the calibration portion 43 is far smaller than that of the light-guiding plate 402. Thus, a part of the light emitted from the line light source is reflected through the calibration portion 43 and enters the calibration region of the scanning module 45, and another part of the light is reflected through the to-be-scanned document and enters the scan document region of the scanning module 45. The point light source 401 is RGB light emitting diodes, and is connected to the light source control circuit.

In the embodiment, the scanning module 45 includes a cylindrical lens array 406 and a CIS array 405. The light reflected through the cylindrical lens array 406 is received by the CIS array 405. Referring to FIG. 6, a scan document region 451 and a calibration region 452 according to another embodiment of the invention are shown. The CIS array 405 of the scanning module, along the first direction X, includes a scan document region 451 and a calibration region 452. The light reflected through the to-be-scanned document is received in the scan document region 451 by a part of the sensing elements, and the light reflected through the calibration portion is received in the calibration region 452 by another part of the sensing elements.

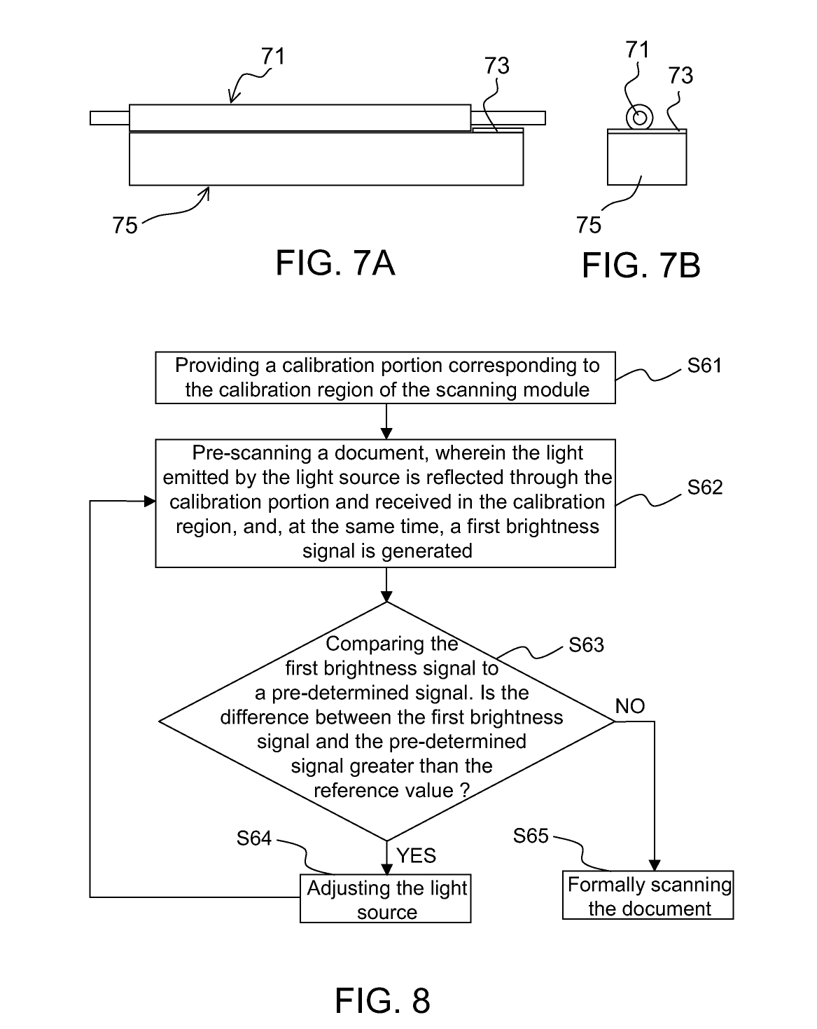

Apart from the above embodiments, the calibration portion is disposed on the surface of the scanning group to realize the real-time automatic feedback of the brightness of the light source. Referring to FIG. 7A and FIG. 7B, two structural diagrams of a scanning device according to yet another embodiment of the invention are respectively shown. A reflector sheet 73 (the calibration portion) is added to a part of the scannable region of the scanning module 75. The reflector sheet 73 is fixed on the scanning module 75, and does not interfere with the position of the paper-feed roller 71. The light source brightness feedback signal reflected through the reflector sheet 73 is received by a corresponding part of the sensing elements of the scanning module 75.

Referring to FIG. 8, a flowchart of a scanning method according to an embodiment of the invention is shown. The scanning method of the invention includes the following steps. In step S61, a calibration portion corresponding to the calibration region of the scanning module is provided, wherein the scanning module, along the first direction, further includes a scan document region, and a light emitted by the light source is reflected through the to-be-scanned document and received in the scan document region. In step S62, a document is pre-scanned, the light emitted by the light source is reflected through the calibration portion and received in the calibration region, and, at the same time, a first brightness signal is generated. In practical application, the first brightness signal can be the average brightness of the signals received in the calibration region. In step S63, the first brightness signal is compared to a pre-determined signal. In practical application, the pre-determined signal can be the average brightness of the signals received in the calibration region when the scanning device is initially calibrated. In step S64, if the difference between the first brightness signal and the pre-determined signal is greater than the reference value, then the light source is adjusted and the step S62 is repeated. In step S65, if the difference between the first brightness signal and the pre-determined signal is smaller than or equal to the reference value, then the document is formally scanned.

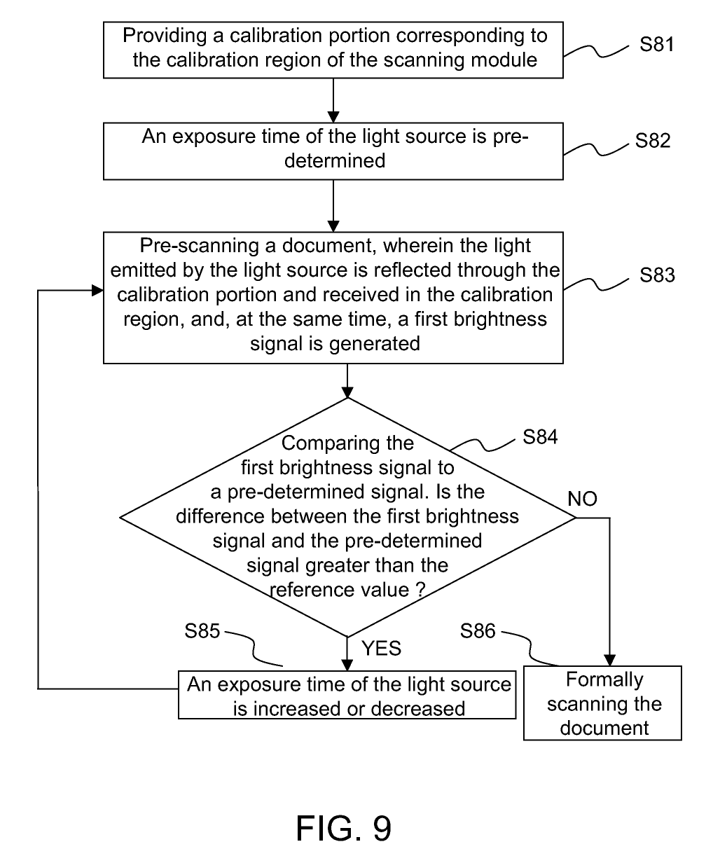

Referring to FIG. 9, a flowchart of a scanning method according to another embodiment of the invention is shown. The scanning method of the invention includes the following steps. In S81, a calibration portion corresponding to the calibration region of the scanning module is provided. The scanning module, along the first direction, further includes a scan document region, and the light emitted by the light source is reflected through the to-be-scanned document and received in the scan document region. In S82, the exposure time of the light source is pre-determined. In S83, a document is pre-scanned, the light emitted by the light source through the calibration portion is reflected and received in the calibration region, and, at the same time, a first brightness signal is generated. In S84, the first brightness signal is compared to a pre-determined signal. S85, if the difference between the first brightness signal and the pre-determined signal is greater than the reference value d, then the exposure time of the light source is increased or decreased and the step S83 is repeated. In practical application, the first brightness signal can be the average brightness Br of the signals received in the calibration region, and the pre-determined signal can be the average brightness Br0 of the signals received in the calibration region when the scanning device is initially calibrated. If Br−Br0>d, then the exposure time of the light source is decreased. If Br0−Br>d, then the exposure time of the light source is increased. In step S86, if the difference between the first brightness signal and the pre-determined signal is smaller than or equal to the reference value, that is, |Br−Br0|≦d, then the document is formally scanned. Besides, during the formal scanning process, the step of performing a generally known image processing algorithm can be included.

By adding the LED brightness feedback mechanism to the CIS scanning device, the influence on the brightness of the LED of the CIS which occurs due to the change in temperature or other factors can be adjusted in real time. Through the calibration portion disposed at one end of the CIS, during the scanning process, the CIS output signal also includes a brightness signal of the calibration portion. The brightness signal can be compared to the signal calibrated for the first time so as to determine whether the brightness of the CIS has changed or not. If the brightness has changed, then relevant circuits of the LED are adjusted by the control system so as to maintain the original brightness of the CIS.

To resolve the problems such as color aberration and brightness change, which occur to the portable scanner due to temperature change, the invention provides a scanning device with automatic calibration of brightness and colors, so that the user no more need to perform manual calibration using a calibration card after the occurrence of brightness change or color aberration. The invention provides the user with great convenience.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning device, comprising:
a scanning group comprising a line light source generating module and a scanning module, wherein the line light source generating module comprises a point light source, a light-guiding plate and a casing, a light emitted by the point light source along a first direction is converted into a line light source through the light-guiding plate disposed in the casing, the light emitted by the line light source along a second direction is emitted from an opening of the casing, the scanning module comprises a scan document region and a calibration region along the first direction, and the light reflected through a to-be-scanned document is received in the scan document region;
a paper-feed roller disposed adjacent to the scanning group for driving the to-be-scanned document;
a calibration portion disposed on the casing or the paper-feed roller, wherein the calibration portion corresponds to the calibration region of the scanning module and the reflected light is received in the calibration region through the calibration portion.

2. The scanning device according to claim 1, wherein the calibration portion is a reflection layer disposed around the paper-feed roller.

3. The scanning device according to claim 1, wherein the calibration portion and the casing are integrally formed in one piece.

4. The scanning device according to claim 1, further comprising:
a light source control circuit for controlling the illumination parameters of the line light source generating module;
a calibration control system electrically connected to the scanning module and the light source control circuit for adjusting the light source control circuit according to the signal feedbacked from the calibration region.

5. The scanning device according to claim 1, wherein the point light source is red/green/blue (RGB) light emitting diodes (LEDs).

6. The scanning device according to claim 1, wherein the scanning module comprises a cylindrical lens array and a CIS array, and the reflected light is received by the CIS array through the cylindrical lens array.

7. A scanning method, comprising the following steps:
A. providing a calibration portion corresponding to a calibration region of a scanning module;
B. pre-scanning a document, wherein a light emitted by a light source is reflected through the calibration portion and received in the calibration region, and, at the same time, a first brightness signal is generated;
C. comparing the first brightness signal to a pre-determined signal;
D. adjusting the light source and repeating the step B if a difference between the first brightness signal and the pre-determined signal is greater than a reference value;
E. formally scanning the document if the difference between the first brightness signal and the pre-determined signal is smaller than or equal to the reference value.

8. The scanning method according to claim 7, wherein the scanning module further comprises a scan document region along the first direction, and the light emitted by the light source is reflected through a to-be-scanned document and received in the scan document region.

9. The scanning method according to claim 7, wherein before the step B, a brightness or an exposure time of the light source is pre-determined.

10. The scanning method according to claim 7, wherein in the step D, an exposure time of the light source is increased or decreased.
